(19) United States
(12) Patent Application Publication
(10) Pub. No.: US 2014/0320515 A1
(43) Pub. Date: Oct. 30, 2014

(54) ROUTING INFORMATION PROCESSING METHOD, COMPUTER PROGRAM, AND SYSTEM

(71) Applicant: International Business Machines Corporation, Armonk, NY (US)

(72) Inventor: Hiroki Yanagisawa, Tokyo (JP)

(73) Assignee: INTERNATIONAL BUSINESS MACHINES CORPORATION, Armonk, NY (US)

(21) Appl. No.: 14/250,554

(22) Filed: Apr. 11, 2014

(30) Foreign Application Priority Data
Apr. 30, 2013 (JP) 2013-095307

(51) Int. Cl. G06T 11/20; G09G 5/02

(52) U.S. Cl. CPC G06T 11/206; G09G 5/02
USPC 345/589

(57) ABSTRACT

Routing information processing method, computer program, and system. A method for processing routes in a graph, the method including coloring vertices in the graph in such a manner that a condition N_{P}>N_{C} is satisfied, wherein a number of vertices in the graph is represented by N_{P} and a number of colors assigned to the vertices is represented by N_{C}, and wherein a series of colors assigned to the vertices is identified uniquely, the series of colors representing a series of vertices corresponding to each of the routes; and storing a series of vertices corresponding to a route as a series of colors assigned to the vertices into the storing means.

### CROSS-REFERENCE TO RELATED APPLICATION

This application claims priority under 35 U.S.C. §119 from Japanese Application No. 2013-095307 filed Apr. 30, 2013, the entire contents of which are incorporated herein by reference.

### BACKGROUND OF THE INVENTION

1. Field of the Invention

The present invention relates to information processing technologies. More specifically, the present invention relates to a method for storing a large amount of routing information more efficiently while ensuring search performance.

2. Description of the Related Art

Nowadays, a large amount of probe car data (coordinate data from GPS device mounted on taxies or trucks) is collected. This data can be converted into routing information data on road networks, using a map matching method. For example, a certain company records daily traveling routes of tens of thousands of GPS-mounted vehicles, thus more than tens of millions of routes are being recoded in total per year. Under such circumstances, a method for efficiently storing such a large amount of routing information data is required. In order to utilize such routing information data, a method for storing the routing information data without sacrificing search performance is needed.

### SUMMARY OF THE INVENTION

According to one aspect of the present invention, a method for processing routes in a graph is provided. The method includes: coloring vertices in the graph in such a manner that a condition N_{P}>N_{C} is satisfied, wherein a number of vertices in the graph is represented by N_{P} and a number of colors assigned to the vertices is represented by N_{C}, and wherein a series of colors assigned to the vertices is identified uniquely, the series of colors representing a series of vertices corresponding to each of the routes; and storing a series of vertices corresponding to a route as a series of colors assigned to the vertices.

According to another aspect of the present invention, a computer program product for processing routes in a graph is provided. The computer program product includes: a computer readable storage medium having program instructions embodied therewith, the program instructions readable/executable by a device to cause the device to perform a method including: coloring vertices in the graph in such a manner that a condition N_{P}>N_{C} is satisfied, wherein a number of vertices in the graph is represented by N_{P} and a number of colors assigned to the vertices is represented by N_{C}, and wherein a series of colors assigned to the vertices is identified uniquely, the series of colors representing a series of vertices corresponding to each of the routes; and storing a series of vertices corresponding to a route as a series of colors assigned to the vertices.

According to yet another aspect of the present invention, a system for processing routes in a graph is provided. The system includes: a memory; a processor device communicatively coupled to the memory; and a module for processing a plurality of routes in a graph coupled to the memory and the processor to carry out the steps of a method including: coloring vertices in the graph in such a manner that a condition N_{P}>N_{C} is satisfied, wherein a number of vertices in the graph is represented by N_{P} and a number of colors assigned to the vertices is represented by N_{C}, and wherein a series of colors assigned to the vertices is identified uniquely, the series of colors representing a series of vertices corresponding to each of the routes; and storing a series of vertices corresponding to a route as a series of colors assigned to the vertices.

### BRIEF DESCRIPTION OF DRAWINGS

FIG. 1 illustrates an example of a method of storing routes.

FIG. 2 illustrates another example of a method of storing routes.

FIG. 3 illustrates a method for storing routes, according to an embodiment of the present invention.

FIG. 4 illustrates a hardware configuration of a computer, according to an embodiment of the present invention.

FIG. 5 illustrates a software configuration of a computer, according to an embodiment of the present invention.

FIG. 6 illustrates the operation of a computer, according to an embodiment of the present invention.

FIG. 7 illustrates a first coloring method, according to an embodiment of the present invention.

FIG. 8 illustrates an experimental result of the first coloring method, according to an embodiment of the present invention.

FIG. 9 illustrates a second coloring method, according to an embodiment of the present invention.

### DETAILED DESCRIPTION OF THE PREFERRED EMBODIMENTS

Hereinafter, best modes for carrying out an embodiment of the present invention will be explained in detail with reference to the drawings. However, the embodiments described below are not intended to limit the claimed invention. It should be noted that all the combinations of the features described in the embodiments are not necessarily essential to solve the problems addressed. Furthermore, the present invention can be implemented in various embodiments and should not be construed as being limited to the description of the embodiments. Throughout the description of the embodiments (unless otherwise indicated), the same elements are referred to with the same reference numerals.

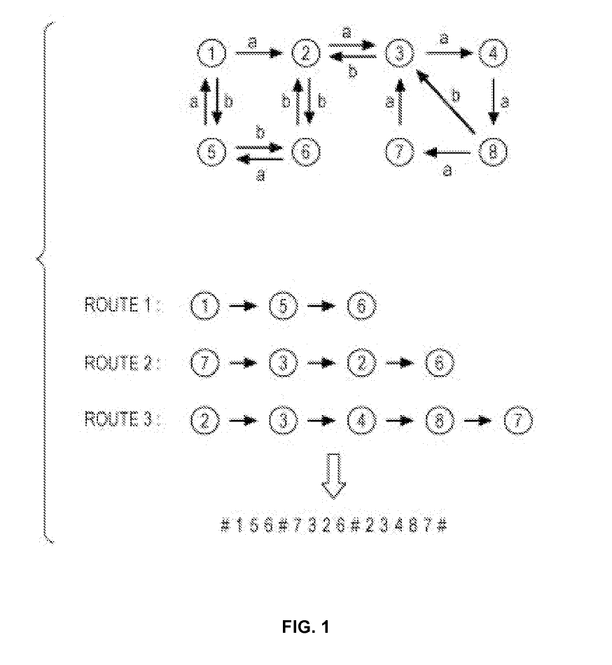

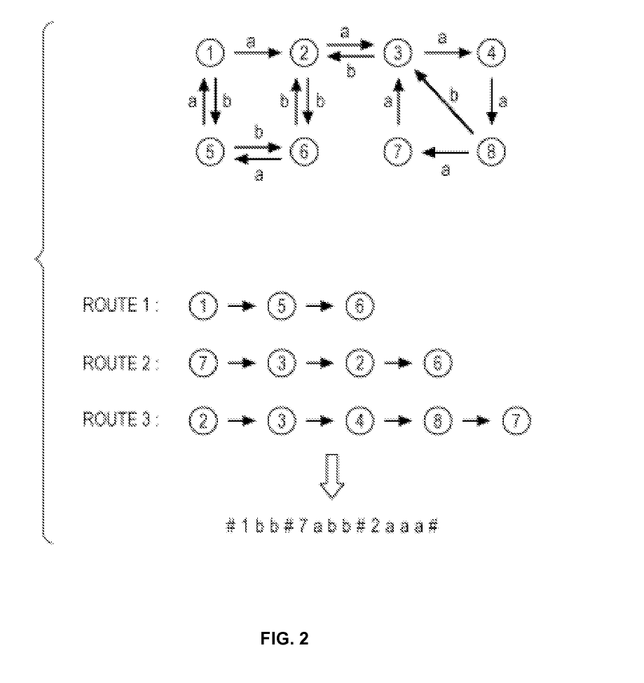

FIGS. 1 and 2 illustrate examples of a method for storing routes. As a first attribute, numbers 1 to 8 are assigned to individual vertices. Furthermore, it is assumed that three routes 1 to 3 are stored. Here, the route 1 includes a series of vertices, that is, a vertex 1, a vertex 5, and a vertex 6, the route 2 includes a series of vertices, that is, a vertex 7, a vertex, 3, a vertex 2, and the vertex 6, and the route 3 includes a series of vertices, that is, the vertex 2, the vertex 3, a vertex 4, a vertex 8, and the vertex 7.

As a first approach, each route is recorded as a series of vertex numbers (recorded using a sign “#” as a separator between routes, for example) (see FIG. 1). In this case, since log n bits are required for the individual vertices in a route, where n represents the number of vertices in a directed graph G, a relatively large storage capacity is necessary. In contrast, for example, in order to search for a route passing through a series of vertices 3→2→6, a substring “326” is searched for from a recorded character string using an existing pattern matching technique on strings. Thus, searching can be performed relatively easily.

Next, as a second approach, identifiers (a, b, c, . . . ) are assigned to directed edges going out of vertices of a directed graph, and each route is recorded as the first vertex number and a series of identifiers of directed edges (see FIG. 2). In this case, only approximately log D bits are required to record one directed edge in a route, where D represents the maximum degree of each vertex. Thus, compared to the first approach, a necessary storage capacity is significantly reduced. In contrast, it is difficult to search for a route.

The present invention has been made in view of the problems addressed above, and an object of the present invention is to provide a method for efficiently recording routing information while allowing the routing information to be searched for easily. In the process of considering the problems addressed above, the inventor has conceived the present invention by treating routing information data on a road network as routing information data in a directed graph having the maximum degree D (a certain small constant). That is, the inventor has conceived the present invention by finding that on a road network, no intersection connecting a large number of roads (for example, a hundred-road junction) exists even though a five-road junction or a six-road junction exists and that a directed graph is obtained when one-way traffic roads are taken into consideration.

That is, the present invention is a method for processing, with a computer including arithmetic control means and storing means, a plurality of routes in a graph, includes a step of coloring, with the arithmetic control means, vertices in the graph in such a manner that a condition N_{P}>N_{C} is satisfied when the total number of vertices in the graph is represented by N_{P} and the total number of colors assigned to the vertices is represented by N_{C} and that a series of colors assigned to the vertices is identified uniquely, the series of colors representing a series of vertices corresponding to each of the routes; and a step of storing a series of vertices corresponding to a route as a series of colors assigned to the vertices into the storing means.

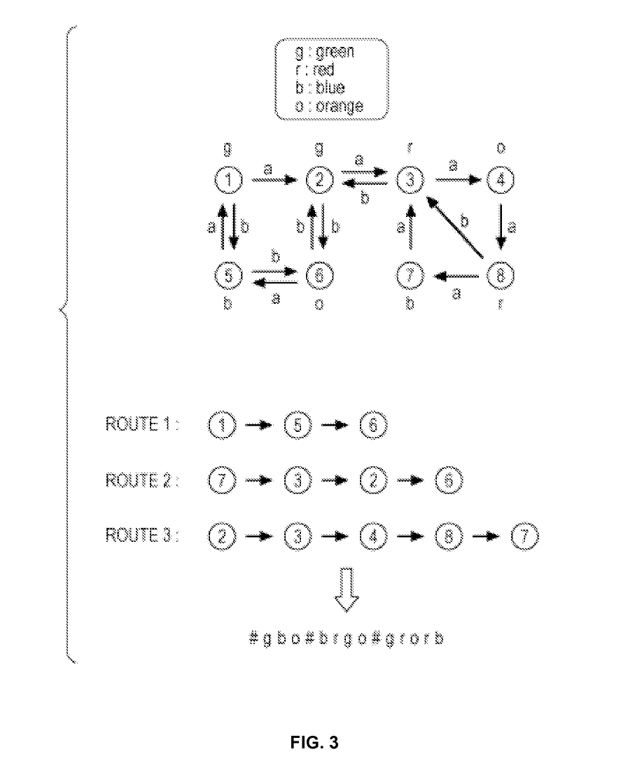

More specifically, in the coloring step, the vertices in the graph can be colored in such a manner that at least one of c(u)≠c(u′) and c(v)≠c(v′) is satisfied for two edges (u,v) and (u′,v′) in the graph, where c(x) represents color assigned to a vertex x. By coloring the vertices in such a manner that the coloring condition mentioned above is satisfied, a directed edge can be uniquely identified on the basis of colors of both endpoints. FIG. 3 illustrates, as an example satisfying the coloring condition mentioned above, that a vertex 1 is colored in green, a vertex 2 is colored in green, a vertex 3 is colored in red, a vertex 4 is colored in orange, a vertex 5 is colored in blue, a vertex 6 is colored in orange, a vertex 7 is colored in blue, and a vertex 8 is colored in red. A route 1 can be represented as a series of colors g→b→o. By recording routing information as a series of colors as described above, each directed edge can be uniquely identified while the storage capacity is reduced. For example, in order to search for a route passing through vertices in the order of 3→2→6, the series of vertices are first regarded as a series of colors r→g→o and a substring “rgo” can be searched for (using an existing pattern matching technique on strings) from character strings recording routing information.

Furthermore, in the coloring step, the vertices in the graph may be colored based on a greedy algorithm. In this case, the vertices in the graph can be colored while a neighboring vertex that is adjacent to a vertex and a different vertex that is adjacent to the neighboring vertex being taken into consideration. In contrast, in the coloring step, coloring may be performed based on harmonious coloring. In this case, coloring may be performed based on the harmonious coloring on the condition that the graph is an undirected graph. Alternatively, coloring may be performed on the condition that the graph is a directed graph, while the directed graph being treated as an undirected graph.

Furthermore, the method may further include a step of receiving an instruction to search for a route, and a step of searching, with the arithmetic control means, for a series of vertices corresponding to the route for which searching is performed as a series of colors assigned to the vertices. In the coloring step, coloring may be performed by providing attributes of a character string to the vertices in the graph. In the storing step, the series of colors may be stored as a character string. In the searching step, a character string corresponding to the route for which searching is performed may be searched for.

The routes may be routes on a road network in which the vertices correspond to intersections. Furthermore, the routes on the road network may be generated from probe car data. Furthermore, the routes may be routes on an information communication network.

It is obvious that substantially the same technical features as those of the case where the present invention described above is understood as a method can also be achieved in the case where the present invention is understood as a computer program product or a computer system.

According to an embodiment of present invention, a method of efficiently recording routing information while allowing the routing information to be searched for easily is provided.

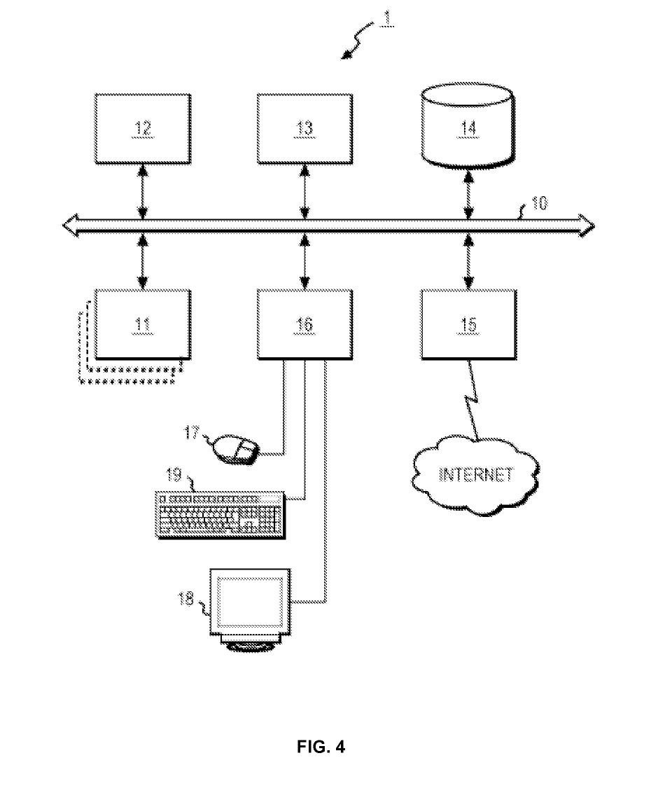

FIG. 4 illustrates a block diagram for explaining a hardware configuration of a personal computer (computer which is classified into a plurality of clusters) 1, according to an embodiment of the present invention. The hardware configuration of computer 1 includes a (low-speed and high-speed) bus 10, a central processing unit (CPU) 11 which is connected to bus 10, a random access memory (RAM: storage device) 12, a read only memory (ROM: storage device) 13, a hard disk drive (HDD: storage device) 14, a communication interface 15, and an input/output interface 16. Computer 1 also includes a mouse 17 which is connected to input/output interface 16, a flat panel display (display device) 18, a keyboard 19, and the like. Although the explanation has been provided on the assumption that computer 1 employs a general personal computer architecture, CPU 11, HDD 14, and the like can be multiplexed, for example, so that higher data processing capacity and availability can be achieved. Furthermore, desktop or other various computer systems can be employed.

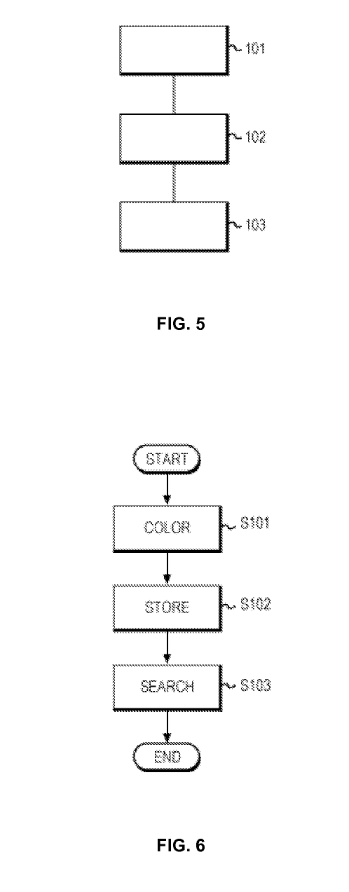

The software configuration of computer 1 includes an operating system (OS) which provides basic functions, application software which uses the functions of the OS, and driver software for input/output devices. The above-mentioned software is loaded on RAM 12, together with various data, and is executed by CPU 11 and the like. Computer 1, as a whole, displays the functions illustrated in FIG. 5 and performs a process illustrated in FIG. 6.

FIG. 5 is a block diagram illustrating functional modules of computer 1. Computer 1 includes a coloring module 101, a storing module 102, and a search module 103.

Data is input and output to and from the individual modules as described below. Graph data of a road network is input from RAM 12, HDD 14, or the like to coloring module 101 in the state in which each route is represented as a series of vertices. In contrast, routing data in which each route is represented as a series of colors is output from coloring module 101. Routing data in which each route is represented as a series of colors is input to and stored into storing module 102. In contrast, routing data corresponding to a search condition is output from storing module 102. A search condition is input from keyboard 19 or the like to search module 103. In contrast, routing data corresponding to a search condition is output from search module 103 and is displayed on display 18.

FIG. 6 is a flowchart for explaining a process performed by computer 1. Computer 1 colors vertices in a graph (step S101), stores, as a series of colors, a route represented as a series of vertices (step S102), and outputs a search result corresponding to a search condition (step S103). If necessary, coloring (S101), storing (S102), and searching (S103) can be repeatedly performed.

An implementation example of coloring (S101) based on a greedy algorithm will now be explained as coloring method 1.

Coloring method 1:

All the vertices within a vertex set V are classified into S (S = V)

while (S is not empty) {
One vertex v is extracted from S (v is eliminated from S)
A color set X is prepared (X is an empty set)
for u in N(v) {

for w in N(u) {

```
  When w has already assigned a color, c(w) is added to X
  }
}
coloring is performed in such a manner that v is colored with a color that is
different from the color assigned to X and the coloring condition is satisfied
}
```

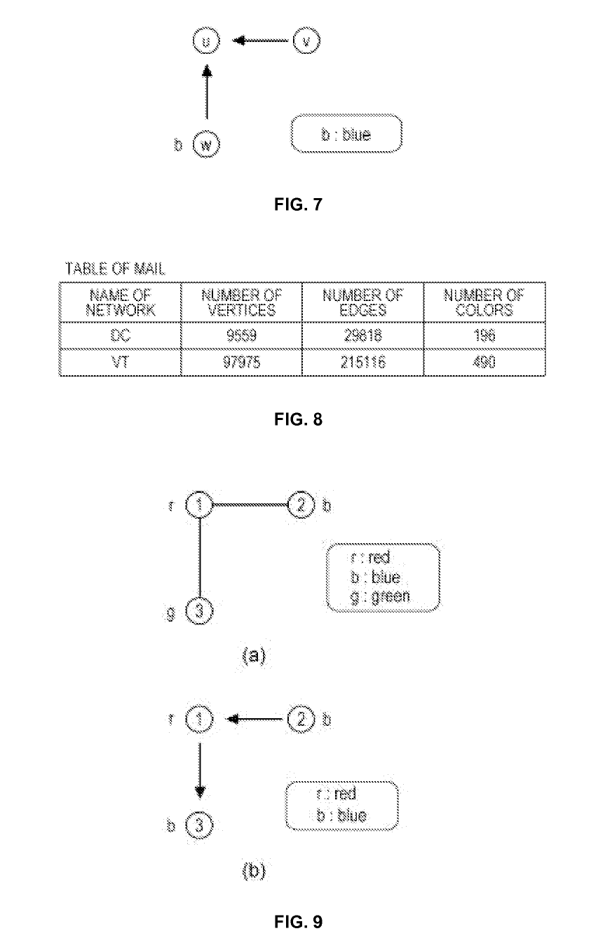

Here, regarding the vertex v, N(v) represents a set of vertices adjacent to the vertex v (vertices having at least one edge going out of or coming into the vertex v). The reason why X is prepared is that no color that can be assigned to u is left if blue is assigned to v in the state illustrated in FIG. 7.

As illustrated in FIG. 8, it was confirmed from the experimental result based on coloring method 1 that the coloring described below can be achieved for two types of road network data in United States. That is, 196 colors are required to perform coloring on a road network (DC) including 9559 vertices (intersections), and 490 colors are required to perform coloring on a road network (VT) including 97975 vertices.

An implementation example of coloring (S101) based on harmonious coloring will now be explained as coloring method 2.

Coloring method 2: A directed graph G is treated as an undirected graph G′ (by setting an undirected edge between vertices having a directed edge directed to at least one direction), and an existing harmonious coloring algorithm is employed. The harmonious coloring is a method for coloring vertices V in an undirected graph in such a manner that the condition described below is satisfied. That is, the condition is that there is no undirected edge whose both endpoints are colored with the same pair of colors as those of any other undirected edge and two vertices connected through an undirected edge are always colored with different colors. The harmonious coloring algorithm can employ the approach described in K. Edwards, The Harmoniouschromatic Number of Bounded Degree Graphs, Journal of the London Mathematical Society, 55(3): 435-447, 1997. With this approach, it is known that when the number of edges in an undirected graph G′ is represented by m and m is greater than a constant M, harmonious coloring using √(2m)+o(√m) colors can be performed on the graph G′.

Coloring is partially different between a coloring rule in which it is assumed that a directed graph is used and harmonious coloring in which it is assumed that an undirected graph is used. More specifically, as illustrated in FIG. 9(a), in harmonious coloring using an undirected graph, vertices 2 and 3 need to be colored in different colors. In contrast, as illustrated in FIG. 9(b), in coloring in which it is assumed that a directed graph is used, vertices 2 and 3 can be colored in the same color. Therefore, coloring may be performed based on harmonious coloring on the condition that a graph on a road network is an undirected graph. Alternatively, coloring may be performed based on harmonious coloring on the condition that a graph on a road network is a directed graph while the directed graph being treated as an undirected graph.

As described above, according to an embodiment of the present invention, the storing efficiency can be increased without sacrificing the search performance. That is, if a graph G can be colored with k colors, the necessary storage capacity for each vertex is approximately log k bits. With the use of coloring method 2 described above, when the number of edges in a graph is represented by m, coloring for the graph G having m edges, which is a sufficiently large number, can be performed such that the condition k=√(2m)+o(√m) is satisfied. When the number of vertices in the graph G is represented by n, m is smaller than or equal to Dn. Thus, the necessary storage capacity for each vertex is represented by the condition: log k=(1/2)log m(1+0(1))≦(1/2)(logn+log D)(1+o(1)) bits. Since log D may be regarded as a small constant, the necessary storage capacity may be approximately (log n)/2 bits. Since the necessary storage capacity for each vertex is approximately log n bits in the case of the first approach described above, it is clear that the necessary storage capacity can be reduced to half in the case where the second approach is used.

In contrast, apart from search for a substring, many of queries that can be quickly responded to in the case where recording is performed based on the first approach among queries about routing information can also be quickly responded to in the case where recording is performed based on this approach. For example, in order to search for a route passing through a vertex v, for each of all the directed edges (v,w) going out of the vertex v, a route passing through the directed edge (v,w) can be searched for (since the maximum degree of v is D, which is a small constant, only constant-factor slowdown is required). Furthermore, it is known that in the case of searching for a character string having the length k, if preprocessing for character strings can be performed in advance, the searching can be completed within 0(k) time by using the technique described in G. Navarro & V. Makinen, Compressed Full-Text Indexes, ACM Computing Surveys 39(1), article 2, 61 pages, 2007, for example.

With any of the coloring methods described above, when the total number of vertices on a road network graph is represented by N_{P} and the total number of colors assigned to the vertices is represented by N_{C}, the condition N_{P}>N_{C} is satisfied. Furthermore, when a series of vertices corresponding to each route is represented by a series of colors assigned to the vertices, the series of colors is identified uniquely. More specifically, for two edges (u,v) and (u′, v′) in a graph on a road network, at least either one of c(u)≠c(u′) or c(v)≠c(v′) is satisfied, where c(x) represents a color assigned to a vertex x. By storing a series of vertices as a series of colors (S102) as described above, the storage capacity can be reduced.

Furthermore, in searching (S103), searching may be performed while a series of vertices corresponding to a route for which searching is performed being treated as a series of colors. In particular, by performing coloring in coloring (S101) by providing attributes of a character string to vertices in a graph on a road network and storing (S102) a series of colors as a character string, searching (S103) can be performed by searching for a character string corresponding to the route for which searching is performed.

An embodiment of the present invention may be in the form of an entirely hardware embodiment, an entirely software embodiment, or an embodiment including elements of hardware and software. In a preferred embodiment, the present invention may be implemented in software including but not limited to firmware, resident software, microcode, parsing picocode, and the like.

Furthermore, the present invention may be in the form of a computer program or a computer-readable medium including program code used by or in association with a computer or any instruction execution system. For the purpose of explanation, a computer-readable medium may be any device that is capable of accommodating, storing, communicating, propagating, or transmitting a program to be used by or in association with any instruction execution system, apparatus, or device. More specifically, the parsing control module described above defines an instruction execution system or a “computer” in this meaning.

A medium may be an electronic, magnetic, optical, electromagnetic, infrared, or semiconductor system (or apparatus or device) or propagation medium. Examples of a computer-readable medium include a semiconductor or solid memory, a magnetic tape, a removable computer diskette, a random access memory (RAM), a read-only memory (ROM), a rigid magnetic disk, and an optical disk. Examples of an optical disk at the present time include a compact disk read only memory (CD-ROM), a compact disk read/write (CD-R/W) memory, and a DVD.

A data processing system suitable for storing, execution, or both of the storing and execution of program code may include at least one processor that is connected directly or indirectly via a system bus to a memory element. The memory element may include a local memory used in the process of the actual execution of program code, a bulk storage device, and a cache memory temporarily providing storing of at least part of the program code so that the number of times reading from the bulk storage device is performed during the execution of the program code can be reduced.

Input/output or I/O devices (including but not limited to a keyboard, a display, a pointing device, and the like) may be connected directly or via an interface I/O controller to the system.

Furthermore, a network adaptor may be connected to the system, and the data processing system may be connected to another data processing system or a remote printer or a storage device via an interface private or public network. A modem, a cable modem, and an Ethernet® card are merely examples of a currently available network adaptor.

What is claimed is:

1. A method for processing routes in a graph, the method comprising:
coloring vertices in the graph in such a manner that a condition N_{P}>N_{C} is satisfied, wherein a number of vertices in the graph is represented by N_{P} and a number of colors assigned to the vertices is represented by N_{C}, and wherein a series of colors assigned to the vertices is identified uniquely, the series of colors representing a series of vertices corresponding to each of the routes; and
storing a series of vertices corresponding to a route as a series of colors assigned to the vertices.

2. The method according to claim 1, wherein the vertices in the graph are colored in such a manner that at least one of c(u)≠c(u′) and c(v)≠c(v′) is satisfied for two edges (u,v) and (u′,v′) in the graph, wherein c(x) represents a color assigned to a vertex x.

3. The method according to claim 1, wherein the vertices in the graph are colored based on a greedy algorithm.

4. The method according to claim 1, wherein the vertices in the graph are colored based on a greedy algorithm, while a neighboring vertex that is adjacent to a first vertex and a second vertex that is adjacent to the neighboring vertex are taken into consideration.

5. The method according to claim 1, wherein coloring is based on harmonious coloring.

6. The method according to claim 5, wherein coloring is based on harmonious coloring if the graph is an undirected graph.

7. The method according to claim 5, wherein coloring is based on harmonious coloring if the graph is a directed graph, while the directed graph is treated as an undirected graph.

8. The method according to claim 1, further comprising:
receiving an instruction to search for a route; and
searching for a series of vertices corresponding to the searched route as a series of colors assigned to the vertices.

9. The method according to claim 8,
wherein coloring includes providing attributes of a character string to the vertices in the graph,
wherein storing includes storing the series of colors as a character string, and
wherein searching includes searching for a character string corresponding to the searched route.

10. The method according to claim 1, wherein the routes are routes on a road network in which the vertices correspond to intersections.

11. The method according to claim 10, wherein the routes on the road network are generated from probe car data.

12. A computer program product for processing routes in a graph, the computer program product comprising a computer readable storage medium having program instructions embodied therewith, the program instructions readable/executable by a device to cause the device to perform a method comprising:
coloring vertices in the graph in such a manner that a condition N_{P}>N_{C} is satisfied, wherein a number of vertices in the graph is represented by N_{P} and a number of colors assigned to the vertices is represented by N_{C}, and wherein a series of colors assigned to the vertices is identified uniquely, the series of colors representing a series of vertices corresponding to each of the routes; and
storing a series of vertices corresponding to a route as a series of colors assigned to the vertices.

13. A system for processing routes in a graph, the system comprising:
a memory;
a processor device communicatively coupled to the memory; and
a module for processing a plurality of routes in a graph coupled to the memory and the processor to carry out the steps of a method comprising:
coloring vertices in the graph in such a manner that a condition N_{P}>N_{C} is satisfied, wherein a number of vertices in the graph is represented by N_{P} and a number of colors assigned to the vertices is represented by N_{C}, and wherein a series of colors assigned to the vertices is identified uniquely, the series of colors representing a series of vertices corresponding to each of the routes; and
storing a series of vertices corresponding to a route as a series of colors assigned to the vertices.

14. The system according to claim 13, wherein the vertices in the graph are colored in such a manner that at least one of c(u)≠c(u′) and c(v)≠c(v′) is satisfied for two edges (u,v) and (u′,v′) in the graph, wherein c(x) represents a color assigned to a vertex x.

15. The system according to claim 13, wherein the vertices in the graph are colored based on a greedy algorithm.

16. The system according to claim 13, wherein the vertices in the graph are colored based on a greedy algorithm, while a neighboring vertex that is adjacent to a first vertex and a second vertex that is adjacent to the neighboring vertex are taken into consideration.

17. The system according to claim 13, wherein coloring is based on harmonious coloring.

18. The system according to claim 17, wherein coloring is based on harmonious coloring if the graph is an undirected graph.

19. The system according to claim 13, further comprising:
receiving an instruction to search for a route; and
searching for a series of vertices corresponding to the searched route as a series of colors assigned to the vertices.

20. The system according to claim 13, wherein the routes are routes on a road network in which the vertices correspond to intersections.
